(19) United States
(12) Patent Application Publication
(10) Pub. No.: US 2026/0014714 A1
(43) Pub. Date: Jan. 15, 2026

(54) BLADE-REPLACEMENT APPARATUS OF A CUTTER

(71) Applicant: INDUSTRO INTERNATIONAL CO., LTD., Taichung City (TW)

(72) Inventor: KUO-CHAN HUANG, Taichung City (TW)

(21) Appl. No.: 18/772,242

(22) Filed: Jul. 14, 2024

(51) Int. Cl. B26B 5/00

(52) U.S. Cl. CPC B26B 5/003

(57) ABSTRACT

A blade-replacement apparatus includes a handle and a switch. The handle includes two shells. The switch is pivotally connected to the handle between two positions. In the first position, the switch locks the shells to each other. In the second position, the switch allows the shells to be separated from each other.

### BACKGROUND OF INVENTION

### 1. Field of Invention

The present invention relates to a cutter and, more particularly, to a blade-replacement apparatus of a cutter.

### 2. Related Prior Art

U.S. Pat. No. 4,922,610 discloses a cutter including a handle for receiving a blade magazine operable to contain multiple blades. The handle includes an opening in a rear end and a slot in an upper portion. An operative one of the blades is movable from the blade magazine via the slot of the handle. For use, the operative blade is held by a clamping piece pivotally connected to the handle. The movement of the operative blade from the blade magazine is inconvenient. Moreover, the holding of the operative blade is inadequate.

U.S. Pat. No. 7,389,587 discloses a utility knife including a handle, a replacement blade holder, a blade carriage, a latching lever, a blade actuator and a locking mechanism. The handle includes two handle portions. The first handle portion includes a rear section and a front section. The rear section receives the replacement blade holder operable to receive multiple spare blades. The front section covers the blade carriage. The second handle portion receives the blade carriage. The blade carriage is operable to receive a blade. The locking mechanism is operable to lock the handle portions to each other. The latching lever extends through a rear portion of the handle and is connected to the blade actuator. The latching lever is rotatable relative to the handle to allow the blade actuator to terminate the locking. Now, the rear and front sections are pivoted together to expose the replacement blade holder and the blade carriage. Alternatively, the front section is not pivoted but only the rear section is pivotable to expose the replacement blade holder only. The structure and operation of the utility knife is complicated.

The present invention is therefore intended to obviate or at least alleviate the problems encountered in the prior art.

### SUMMARY OF INVENTION

It is the primary objective of the present invention to provide a cutter with convenient a blade-replacement apparatus.

To achieve the foregoing objective, the blade-replacement apparatus includes a handle and a switch. The handle includes two shells. The switch is pivotally connected to the handle between two positions. In the first position, the switch locks the shells to each other. In the second position, the switch allows the shells to be separated from each other.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a cutter according to the preferred embodiment of the present invention;

FIG. 2 is an exploded view of the cutter shown in FIG. 1;

FIG. 3 is another exploded view of the cutter shown in FIG. 1;

FIG. 4 is a partial view of the cutter shown in FIG. 1;

FIG. 5 is a partial, cross-sectional view of the cutter shown in FIG. 1; and

FIG. 6 is a partial, cross-sectional view of the cutter shown in FIG. 1.

### DETAILED DESCRIPTION OF PREFERRED EMBODIMENT

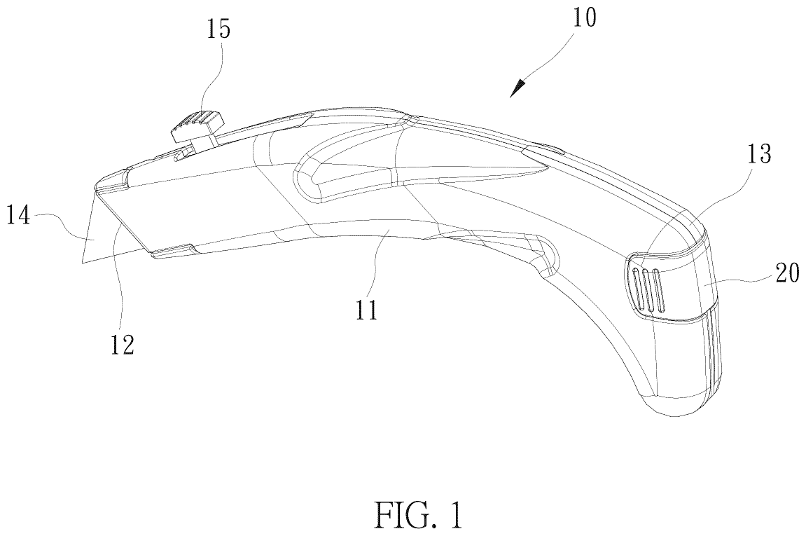

Referring to FIGS. 1 through 6, a cutter 10 includes a handle 11, an operative blade 14 and a blade-replacement apparatus according to the preferred embodiment of the present invention. The handle 11 includes a front end 12 and a rear end 13. The rear end 13 extends downward so that the handle 11 shaped like an “L.”

The operative blade 14 is extensible from the handle 11 through a slot (not numbered) in the front end 12. A pusher 15 includes an upper portion located over a top of the handle 11 and a lower portion extending through a slot or slit made in an upper portion of the handle 11. The lower portion of the pusher 15 is connected to the operative blade 14. The pusher 15 is movable relative to the handle 11 so that the pusher 15 is operable to move a front end of the operative blade 14 out of the handle 11.

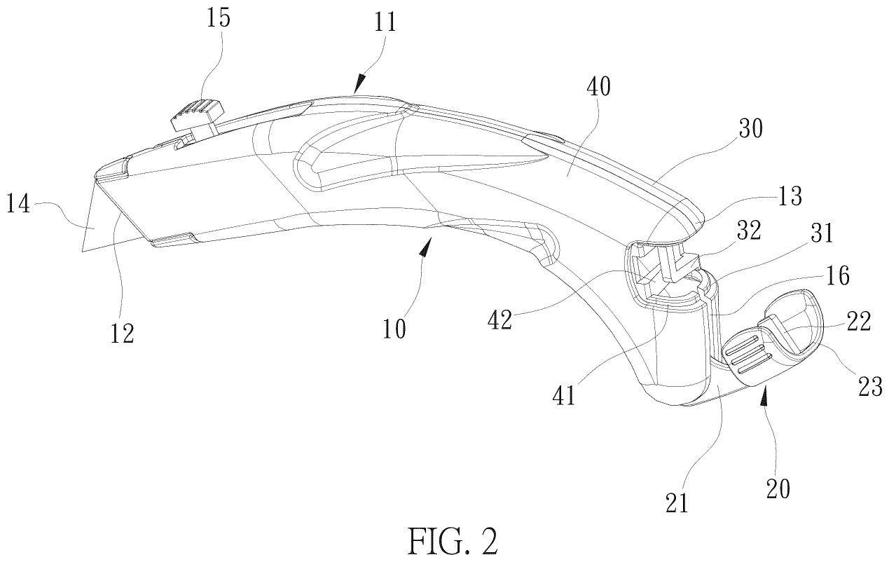

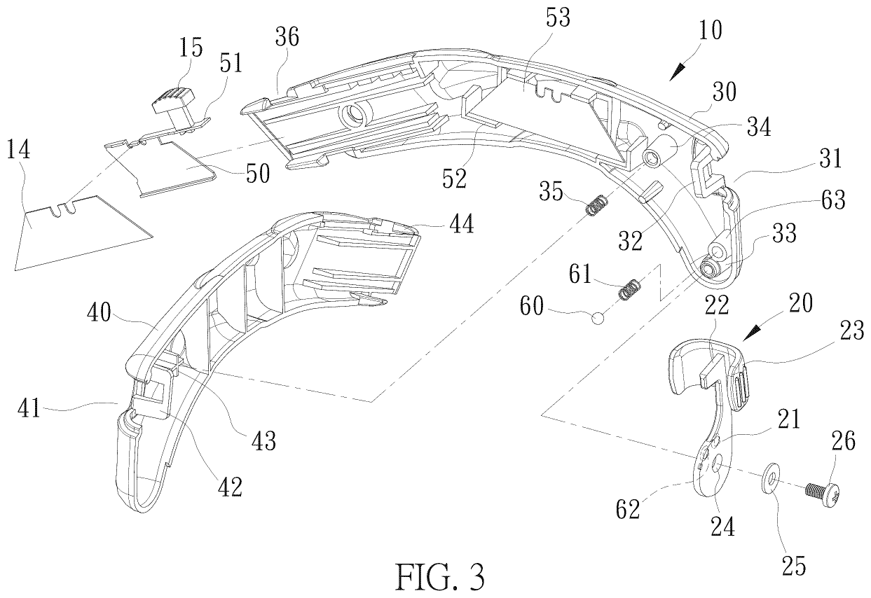

The switch 20 includes an external portion located out of the rear end 13 of the handle 11 and an internal portion pivotally connected to an internal portion of the handle 11 by a screw 26 (FIG. 3) between two positions. In the first position shown in FIG. 1, the switch 20 keeps the handle 11 closed. In the second position shown in FIG. 2, the switch 20 allows the handle 11 to be opened.

Referring to FIG. 3, the handle 11 is opened, i.e., a main shell 30 is separated from a minor shell 40. The shells 30 and 40 together form the handle 11. A spring 35, a carrier 50 and a spare blade 53 can be moved from the handle 11 when the handle 11 is opened. The switch 20, a washer 25, a ball 60 and a compression spring 61 are detachable from the handle 11 by disengaging screw 26 from an internal portion of the main shell 30.

The operative blade 14 is trapezoid, and so is the spare blade 53. Each of the blades 14 and 53 includes an upper edge, a lower edge extending in parallel to the upper edge, and two slant edges extending between the upper and lower edges. The lower edge is a cutting edge. The lower edge extends longer than the upper edge so that there are two tips at two ends of the cutting edge. The upper edge includes at least one recess.

The carrier 50 is used to receive the operative blade 14. The carrier 50 includes at least one protuberance insertable in the at least one recess of the upper edge of the operative blade 14. The carrier 50 is formed with a connector 51. The connector 51 is connected to the lower portion of the pusher 15.

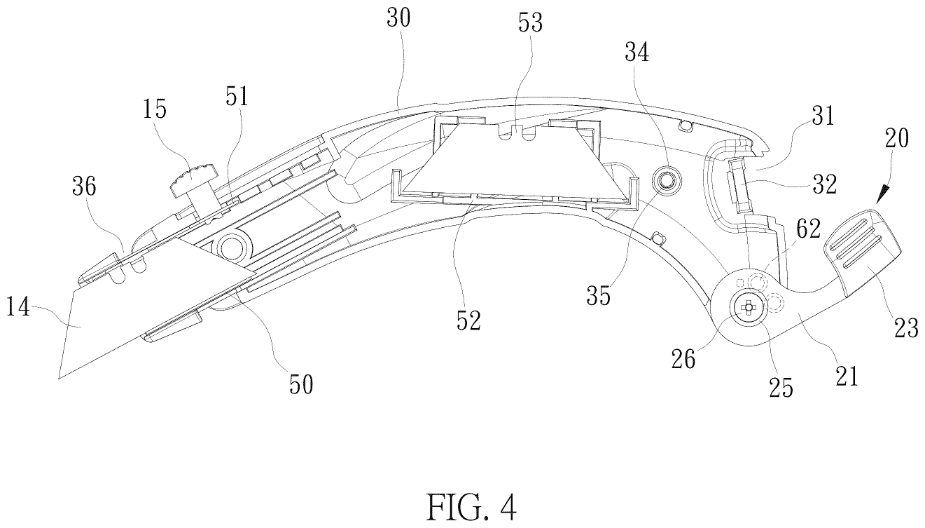

Referring to FIG. 4, the carrier 50 is located adjacent to an internal side of the main shell 30. The connector 51 supports the lower portion of the pusher 15 to keep the upper portion of the pusher 15 above the main shell 30.

Referring to FIG. 2, each of the shells 30 and 40 includes a recess in an upper portion. The recesses of the shells 30 and 40 together become the slot in the upper portion of the handle 11, which allows the lower portion of the pusher 15 to move back and forth. The pusher 15 is operable to move one of the tips of the operative blade 14 into or out of the front end 12 of the handle 11.

Referring to FIGS. 3 and 4, the spare blade 53 is located on a holder 52 formed on the internal side of the main shell 30 when the handle 11 is opened, i.e., the shells 30 and 40 are separated from each other. The spare blade 53 is kept in the handle 11 when the handle 11 is closed. The operative blade 14 is removable from the carrier 50 before the spare blade 53 is movable to the carrier 50 from the holder 52 when the handle 11 is opened again.

A wedge-shaped recess 36 is made in the upper portion of the main shell 30 and another wedge-shaped recess 36 is made in a lower portion of the main shell 30. A wedge-shaped tab 44 is formed on the upper portion of the minor shell 40 and another wedge-shaped tab 44 is formed on a lower portion of the minor shell 40.

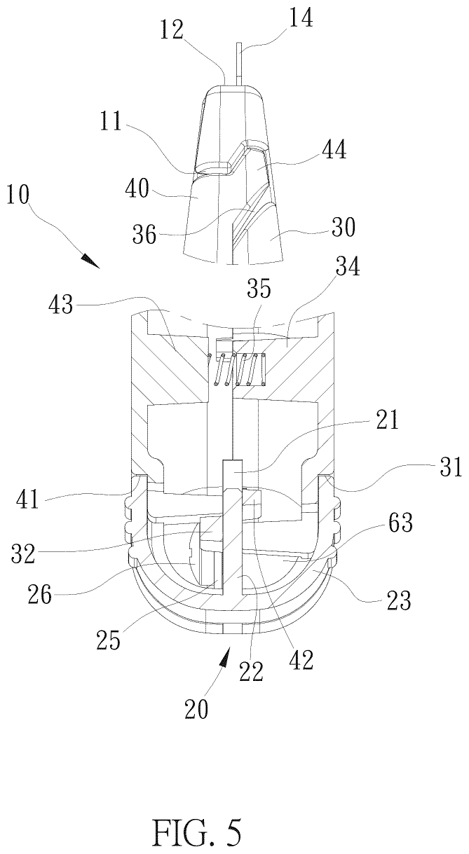

Referring to FIG. 5, the wedge-shaped tabs 44 are inserted in the wedge-shaped recess 36 to keep a front portion of the main shell 30 next to a front portion of the minor shell 40. The front portion of the main shell 30 and the front portion of the minor shell 40 together form the front end 12 of the handle 11. Each of the wedge-shaped recesses 36 and the corresponding wedge-shaped tab 44 together form an oblique halving joint. The main shell 30 is moved relative to the minor shell 40 toward the rear end 13 of the handle 11 or the minor shell 40 is relative to the main shell 30 toward the front end 12 of the handle 11 to allow the main shell 30 and the minor shell 40 to place the main shell 30 in the right position next to the minor shell 40, i.e., to close the handle 11. The main shell 30 is movable relative to the minor shell 40 in an opposite direction to open the handle 11.

In the so-called oblique halving joints, the wedge-shaped tabs 44 extend to the front end 12 of the handle 11 from the internal side of the minor shell 40, and the wedge-shaped recesses 36 extend into the internal side of the main shell 30 toward the front end 12. Thus, the wedge-shaped recesses 36 receive the wedge-shaped tabs 44 as the main shell 30 is moved relative to the minor shell 40 toward the rear end 13 of the handle 11.

Referring to FIGS. 3 and 5, a frame 32 extends from the internal side of the main shell 30. The frame 32 includes an aperture. A frame 42 extends from the internal side of the minor shell 40. The frame 42 includes an aperture. The frames 32 and 42 are overlapped. The apertures of the frames 32 and 42 receive a latch 22 extending from the switch 20. Thus, the frame 32 and 42 are kept overlapped. That is, a rear portion of the main shell 30 is locked to a rear portion of the minor shell 40. Thus, the rear portion of the main shell 30 and the rear portion of the minor shell 40 together form the rear end 13 of the handle 11.

Moreover, the main shell 30 is formed with a cutout 31. The frame 32 includes a root located adjacent to the cutout 31. The minor shell 40 includes a cutout 41. The frame 42 includes a root located adjacent to the cutout 41.

The switch 20 further includes a cover 23 formed at an end of the latch 22, i.e., the latch 22 extends a middle portion of the cover 23. The cutouts 31 and 41, the frames 32 and 42 and the latch 22 are covered by the cover 23 as the main shell 30 is connected to the minor shell 40. The shells 30 and 40 are further kept next to each other by the cover 23.

The switch 20 further includes a lever 21. The latch 22 extends forward from a front edge of an upper portion of the lever 21. The cover 23 includes two lateral portions extending laterally from a rear edge of the upper portion of the lever 21. An aperture 24 is made in a lower portion of the lever 21. The aperture 24 receives the screw 26, which extends in a tube 33 formed on the internal side of the main shell 30 via the washer 25. Thus, the switch 20 is pivotally connected to the handle 11.

Referring to FIG. 2, the handle 11 includes a slit 16 between rear portions of the shells 30 and 40. The slit 16 is in communication with the cutouts 31 and 41. The lever 21 is extends from the handle 11 through the slit 16. The slit 16 allows the lever 21 to be pivoted.

Referring to FIGS. 3 and 5, the main shell 30 includes a bore 63 located next to the tube 33. The bore 63 receives the compression spring 61 and the ball 60. The compression spring 61 biases a portion of the ball 60 out of the bore 63. The exposed portion of the ball 60 is located in a selected one of multiple dents 62 made in a side of the lever 21. Thus, the lever 21 can be kept in a selected one of multiple angles relative to the handle 11.

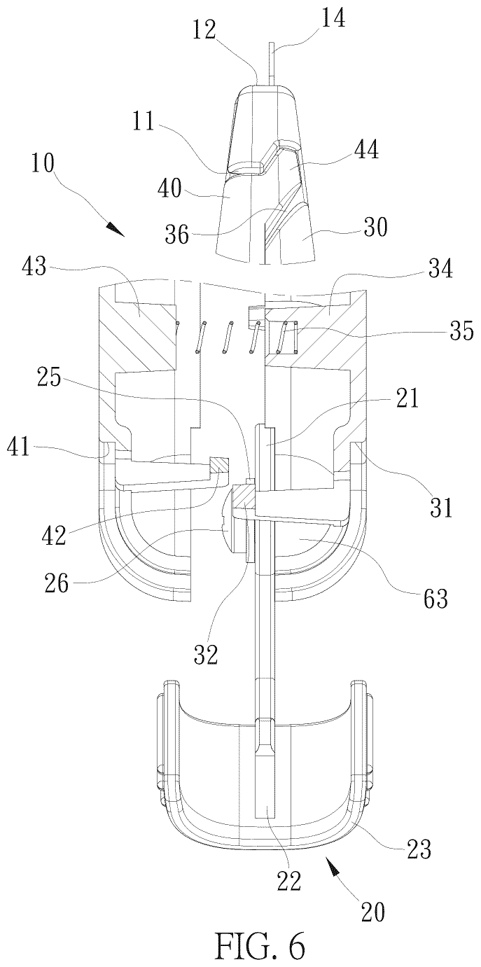

Referring to FIGS. 3 and 6, the latch 22 is moved from the apertures of the frames 32 and 42 so that the frames 32 and 42 are movable from each other. The spring 35 is arranged between the shells 30 and 40, thereby tending to open the rear end 13 of the handle 11. The spring 35 is preferably a compression spring formed with an end located in a hollow stem 34 extending from the internal side of the main shell 30 and another end in contact with a pressing rod 43 extending from the internal side of the minor shell 40. The spring 35 tends to push the main shell 30 from the minor shell 40.

Referring to FIG. 5, the latch 22 is inserted in the apertures of the frames 32 and 42, thereby keeping the main shell 30 next to the minor shell 40. The cover 23 covers the cutouts 31 and 41. Thus, the main shell 30 and the minor shell 40 keeps the spring 35 compressed.

Referring to FIGS. 1 through 6, the cutter 10 includes the oblique halving joint, which consists of the wedge-shaped tabs 44 and the wedge-shaped recess 36, to ensure that the front end 12 of the handle 11 is closed before the rear end 13. In the closing position, the switch 20 keeps the rear end 13 closed. The handle 11 is kept closed as the ends 12 and 13 are kept closed. In the opening position, the switch 20 allows the shells 30 and 40 to be separated from each other, i.e., allows the handle 11 to be opened. Accordingly, the spare blade 53 is allowed to replace the operative blade 14.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A blade-replacement apparatus comprising:
a handle comprising two shells; and
a switch pivotally connected to the handle between a first position for locking the shells to each other and a second position for allowing the shells to be separated from each other.

2. The blade-replacement apparatus according to claim 1, wherein each of the shells comprises a frame formed on an internal side, wherein the switch comprises a latch insertable in the frames, thereby locking the shells to each other.

3. The blade-replacement apparatus according to claim 2, wherein the switch further comprises a lever extending from the latch and comprising an end pivotally connected to the handle.

4. The blade-replacement apparatus according to claim 3, further comprising a spring and a ball, wherein the lever comprises multiple dents, wherein one of the shells comprises a bore for receiving the spring and the ball, wherein the spring biases a portion of the ball into a selected one of the dents of the lever.

5. The blade-replacement apparatus according to claim 1, wherein the switch comprises a cover for locking the shells to each other and.

6. The blade-replacement apparatus according to claim 5, wherein the switch further comprises a lever extending from the cover and comprising an end pivotally connected to the handle.

7. The blade-replacement apparatus according to claim 6, further comprising a spring and a ball, wherein the lever comprises multiple dents, wherein the first shell comprises a bore for receiving the spring and the ball, wherein the spring biases a portion of the ball into a selected one of the dents of the lever from the bore.

8. The blade-replacement apparatus according to claim 5, wherein each of the shells further comprises a cutout for receiving a portion of the cover.

9. The blade-replacement apparatus according to claim 1, further comprising a spring for pushing the shells from each other.

10. The blade-replacement apparatus according to claim 1, wherein the first shell comprises a wedge-shaped recess, wherein the second shell comprises a wedge-shaped tab insertable in the wedge-shaped recess to close the first end of the handle before the rear end.
